(19) United States
(12) Patent Application Publication
(10) Pub. No.: US 2009/0106121 A1
(43) Pub. Date: Apr. 23, 2009

(54) UNIVERSAL BUSINESS TO MEDIA TRANSACTION SYSTEM

(75) Inventors: Jacek Waksmundzki, Warsaw (PL); Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,256

(22) Filed: Oct. 21, 2008

Related U.S. Application Data
(60) Provisional application No. 60/981,710, filed on Oct. 22, 2007.

(51) Int. Cl. G06Q 30/00; G06Q 40/00

(52) U.S. Cl. 705/26; 705/37

(57) ABSTRACT

A computer network based universal transaction system (CNBUTS) architecture that enables transaction between one or more offer providers and one or more customers relating to offers of wares (e.g., goods/services) by the offer providers. In one embodiment, the architecture of the CNBUTS includes a universal agent system, one or more offering systems and one or more marketplace systems. The universal agent system receives one or more offers of wares available for transactions. Each offering system enables offer providers to define the offer(s) of wares available for transaction. Each marketplace system receives the offer(s) of wares from the universal agent system, presents the customers the offer(s) of wares, receives transaction requests from the customers, and communicates received transaction requests to the universal agent system. The universal agent system communicates the offer(s) of wares from the offering system(s) to the marketplace system(s) and processes transaction requests received from the marketplace system(s).

### RELATED APPLICATION INFORMATION

This application claims priority from U.S. Provisional Patent Application Ser. No. 60/981,710 entitled “UNIVERSAL BUSINESS TO MEDIA TRANSACTION SYSTEM” filed on Oct. 22, 2007, which is incorporated by reference herein in its entirety.

### FIELD OF THE INVENTION

The present invention relates generally to facilitating transactions among customer and offer providers, and more particularly to brokering of transactions relating to any goods or services in any business domain using multiple analog and digital media.

### BACKGROUND OF THE INVENTION

The Internet and other computer networks have proven to be a useful medium for connecting those who offer goods or services with persons seeking to obtain goods or services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In other examples, a person might order a pair of skis from a ski shop or an automobile part from an automobile parts dealer. In each of the foregoing examples, the ordering/scheduling function is integrated with the system that presents information about the available good/service. Furthermore, access to the system that presents information about the available goods/services may be limited to particular marketplaces. For example, the doctor's office, car rental agency's, restaurant's, ski shop's or parts dealer's Web site might be accessible via a Web portal, but not via a mobile phone portal or a digital television system. Additionally, the customers seeking goods/services may be presented with a myriad of different ordering/scheduling systems and processes in order to order/reserve a variety of differing goods/services since the customers directly interface with the offering systems.

### SUMMARY OF THE INVENTION

The present invention provides for a computer network based universal transaction system (CNBUTS). The CNBUTS provides easy brokering of transactions relating to wares between customers and offer providers. In general, a “ware” is any good or service that an individual or an entity may reserve, schedule, order, buy, purchase, sell, deliver, provide, receive, rent, lease, or the like from/to another. The terms “ware” and “good/service” may be used interchangeably herein. In general, a “customer” is any individual or entity that may reserve, schedule, order, buy, purchase, receive, rent, lease, or the like a good or service. The terms “customer” and “buyer/client” may be used interchangeably herein. Further, a “transaction” refers to any activity involving a good or service including reserving, scheduling, ordering, buying, purchasing, selling, delivering, providing, receiving, renting, leasing, or the like of a good or service.

The present invention provides universality by allowing for the inclusion of every customer who desires to participate and every offer provider who desires to participate through every analog and digital media (e.g. newspaper, billboard, Internet, ITV, cell phone, PDA, etc.) and through multiple marketplaces that desire to participate (e.g., universal portals, linked services portals, specialty portals, media portals, etc.).

The CNBUTS includes a number of components that communicate with one another via computer networks. The computer networks may, in general, be any public network(s), any private network(s), or any combination of public and private network(s) that provide for the communication of data between devices connected to the network(s). Examples of such computer network(s) include the Internet, private switched telephone networks, cellular telephone networks, cable and satellite television networks, wireless networks, and the like.

The present invention includes various aspects and features. In one aspect, an architecture of a CNBUTS that enables transactions between one or more offer providers and one or more customers, wherein the transactions relate to offers of wares by the offer providers, includes a universal agent system, one or more offering systems and one or more marketplace systems. The universal agent system is enabled to receive one or more offers of wares available for transaction. Each offering system enables offer providers to define one or more offers of wares available for transaction with customers. In this regard, an offer of wares defined by an offer provider may include information indicating whether or not the universal agent system is delegated authority to complete transactions with customers relating to the offer of wares. Each marketplace system is enabled to receive the one or more offers of wares from the universal agent system, present the customers the one or more offers of wares, receive transaction requests from the customers relating to the one or more offers of wares, and communicate received transaction requests to the universal agent system. The universal agent system communicates the one or more offers of wares from the one or more offering systems to the one or more marketplace systems and processes transaction requests received from the one or more marketplace systems.

In another aspect, an architecture of a CNBUTS that enables transactions between one or more offer providers and one or more customers, wherein the transactions relate to offers of wares by the offer providers, includes a universal agent system implemented in the form of computer readable program code executable by a computer processor, a plurality of offering systems implemented in the form of computer readable program code executable by separate computer processors, a plurality of offering interface brokers, a plurality of marketplace systems implemented in the form of computer readable program code executable by separate computer processors, and a plurality of marketplace interface brokers. The universal agent system is enabled to receive one or more offers of wares available for transaction. Each offering system enables offer providers to define one or more offers of wares available for transactions with customers. In this regard, an offer of wares as defined by an offer provider may include information indicating whether the universal agent system is delegated authority to complete transactions with customers relating to the offer of wares. Each offering interface broker corresponds with one of the offering systems and provides an interface between its corresponding offering system and the universal agent system for communication via a computer network between the computer processor executing universal agent system program code and the computer processor executing offering system program code. Each marketplace system is enabled to receive the one or more offers of wares from the universal agent system, present the customers the one or more offers of wares, receive transaction requests from the customers relating to the one or more offers of wares, and communicate received transaction requests to the universal agent system. Each marketplace interface broker corresponds with one of the marketplace systems and provides an interface between its corresponding marketplace system and the universal agent system for communication via a computer network between the computer processor executing universal agent system program code and the computer processor executing marketplace system program code. The universal agent system communicates the one or more offers of wares from the offering systems to the marketplace systems using the offering and marketplace interface brokers and processes transaction requests received from the plurality of marketplace systems.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing one embodiment of a computer network based universal transaction system presenting involved actors and components; and

FIG. 2 is a block diagram showing the architecture of one example of a computing system that may be utilized in implementing various components of the computer network based universal transaction system.

### DETAILED DESCRIPTION

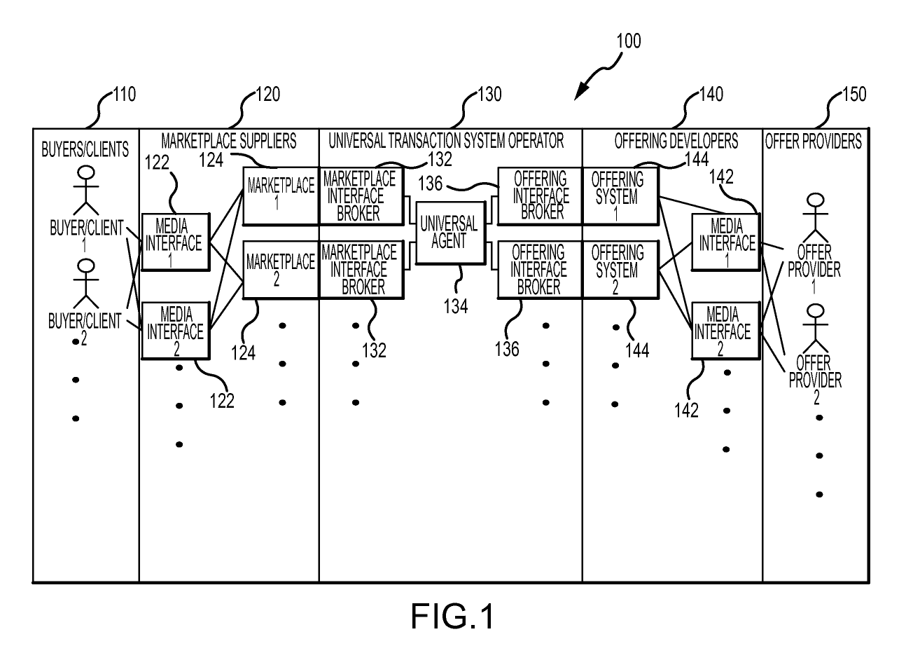

FIG. 1 shows one embodiment of a computer network based universal transaction system (CNBUTS) 100. The CNBUTS 100 conforms to the business to media (B2M) transaction standard. In general, the B2M transaction standard specifies a standard that provides for the visualization of, and the buying, renting/scheduling of goods/services, simultaneously, in real time, and over multiple analog and digital media in multiple analog and digital marketplaces. The B2M transaction standard is more specifically described in a separate United States patent application filed contemporaneously herewith entitled “BUSINESS TO MEDIA TRANSACTION STANDARD” (which application claims priority from U.S. Provisional Application No. 60/981,722 filed Oct. 22, 2007), the entire disclosure of which is incorporated by reference herein.

The CNBUTS 100 represents one possible implementation of the B2M transaction standard and it is done in digital and computer network enabled technology. As illustrated in FIG. 1, CNBUTS 100 includes five (5) groups of actors and six (6) types of components. The five groups of actors are: buyers/clients 110, marketplace suppliers 120, the universal transaction system operator 130, offering developers 140 and offer providers 150. The six types of components are: media interface 122 and 142, marketplace 124, the marketplace interface broker 132, the universal agent 134, the offering interface broker 136 and the offering system 144. The characteristics and roles of the various components of and actors involved in the CNBUTS 100 are described below.

### CNBUTS 100 Components

The media interfaces 122, 142 are a set of tools enabling communication through one-way media (e.g. billboards, newspapers, radio, analog TV, etc.) and two-way media (e.g. Internet, mobile phones, digital TV, etc.). One-way communication media are used by buyers/clients 110 to get information from marketplaces 124, and two-way communication media are used between offer providers 150 and offering systems 144 as well as between buyers/clients 110 and marketplaces 124. In this regard, the media interfaces 142 operated by the offering developers 140 should provide for two-way communication, whereas the media interfaces 122 operated by the marketplace suppliers 120 may provide for one-way or two-way communication. Sets of tools are different for digital media and analog media. Tools for digital media include, for example, web applications, digital television (DTV) applications, mobile web applications, local applications (e.g., graphical user interfaces), and the like. Tools for analog media include, for example, graphics, texts, sounds, and the like.

The marketplace component 124 is a computer network enabled computer system where goods/services are available through media interfaces 122 to the buyers/clients 110. In this regard, marketplaces 124 may also be referred to herein as marketplace systems 124. The marketplace 124 offers goods/services available at the universal agent component 134 to the buyers/clients 110 and mediates within the transaction process of those goods/services between the universal agent 134 and the buyers/clients 110. The marketplace 124 is a separate computer system from the universal agent 134 and uses the marketplace interface broker component 132 to communicate with the universal agent 134.

The marketplace interface broker (MIB) 132 is a tool enabling integration of marketplaces 124 with the universal agent 134. The MIB 132 provides functionality dependent upon different kinds of marketplaces 124 (e.g. different technologies, different business domains, different business functionality, etc.) and the ability to be connected to the universal agent 134. The MIB 132 communicates with universal agent 134 through a computer network (not shown in FIG. 1).

The universal agent 134 is a computer network enabled computer system capable of processing all kinds of transactions (e.g. buying, selling, renting, reserving, scheduling, etc.) of all kinds of goods/services on behalf of an offer provider 150 and the handling of those transactions between marketplace interface brokers 132 and offering interface brokers 136. In this regard, the universal agent 134 may also be referred to herein as the universal agent system 134. The universal agent 134 passes the goods/services offer from the offering systems 144 (placed there by offer providers 150) to the marketplaces 124 and informs offer providers 150 through the offering systems 144 about transaction requests from the marketplaces 124. The universal agent 134 is connected via a computer network (not shown in FIG. 1) to one or more offering systems 144 (the number of service offering systems 144 is unlimited) using offering interface brokers 136 and to one or more marketplaces 124 (the number of marketplaces 124 is unlimited) using marketplace interface brokers 132. There is only one universal agent 134 in the CNBUTS 100 which is capable of serving every type of business domain.

The offering interface broker (OIB) 136 is a tool enabling integration of offering systems 144 with the universal agent 134. The OIB 136 provides functionality dependent upon different kinds of offering systems 144 (e.g. different technologies, different business domains, different logical approaches, etc.) and the ability to be connected to the universal agent 134. The OIB 136 communicates with the universal agent 134 through a computer network (not shown in FIG. 1).

The offering system 144 is a computer network enabled computer system where goods/services are defined and managed by offer providers 150. In the CNBUTS 100 of FIG. 1, offer providers 150 define and manage goods/services with an offering system 144 through media interfaces 142 (e.g. using web applications, DTV applications, mobile web applications, local applications). The offering system 144 makes goods/services offered by offer providers 150 available to the universal agent 134 and mediates in the transaction process of those goods/services between the universal agent 134 and the offer provider 150. The offering system 144 is a separate computer system from the universal agent 134 and uses the offering interface broker 136 to communicate with the universal agent 134.

### CNBUTS 100 Actors

The role of buyers/clients 110 is to buy/rent/reserve/schedule/etc. goods/services available on multiple marketplaces 124 through multiple media 122. Although two buyers/clients 110 are depicted in FIG. 1, there are no limits on the number of buyers/clients 110 using CNBUTS 100.

The role of marketplace suppliers 120 is to provide marketplaces 124 in any area of perceived market need (e.g. computer shops, car shops, hair-dressers, ski rentals, hotels, etc.). Marketplace suppliers 120 use marketplace interface brokers 132 to integrate marketplaces 124 with the universal agent 134. More details regarding integration of marketplaces 124 with the universal agent 134 is provided in a separate United States patent application filed contemporaneously herewith entitled “BUSINESS TO MEDIA TRANSACTION BUSINESS PROCESS” (which application claims priority from U.S. Provisional Application No. 60/981,732 filed Oct. 22, 2007), the entire disclosure of which is incorporated by reference herein. The marketplaces 124 can be unique (e.g. auto repair appointment reservations or auto parts purchase, etc.), linked (e.g. hotel, restaurant and rental car reservations) or universal (every registered offer provider, limited only by the parameters of the buyer/client search). Marketplace suppliers 120 also provide media interfaces 122 for communication between marketplaces 124 and buyers/clients 110. The media used for communication can be analog (e.g. newspapers, billboards, etc.) and/or digital (e.g. Internet, mobile phones, digital TV, etc.). It is a choice of marketplace suppliers 120 what communication possibilities and which media are available for buyers/clients 110. An unlimited number of marketplaces 124 can be created and an unlimited number of marketplace suppliers 120 can be involved in the CNBUTS 100.

The role of the universal agent supplier 130 is to provide the universal agent 134, which is responsible for exchanging information between offering systems 144 and marketplaces 124 in both directions and is responsible for completing transactions on behalf of an offer provider 150, if the offer provider 150 decides to delegate transaction handling to the universal agent 134.

The offering developer 140 utilizes the offering interface broker component 136 to develop and configure the offering system 144 for a specific category of goods/services (e.g. ski rental equipment reservations or ski equipment purchase), to define delegations to the universal agent 134, and to name specific existing marketplaces 124 where the offer will be available to the buyers/clients 110. More details regarding integration of offering systems 144 with the universal agent 134 are provided in a separate United States patent application filed contemporaneously herewith entitled “BUSINESS TO MEDIA TRANSACTION BUSINESS PROCESS” (which application claims priority from U.S. Provisional Application No. 60/981,732 filed Oct. 22, 2007), the entire disclosure of which is incorporated by reference herein. The delegations to the universal agent 134 may be sufficient to allow the universal agent 134 to complete the transaction. The universal agent 134 may provide a universal service code (USC) associated with each good/service, which facilitates the use of one-way media for presenting those goods/services to the buyers/clients 110 on the marketplaces 124. However, a USC may not be required to use one-way media. In general, a USC is a unique sequence of letters, numerals, symbols or combination of letters, numerals and/or symbols that is associated with a particular good/service. USCs (in the context of reserving services) are more specifically described in a separate United States patent application filed contemporaneously herewith entitled “UNIVERSAL SERVICE CODE FOR RESERVATIONS” (which application claims priority from U.S. Provisional Application No. 60/981,725 filed Oct. 22, 2007), the entire disclosure of which is incorporated by reference herein. There can be an unlimited number of offering systems 144 categories and an unlimited number of offering developers 140 can be involved in the CNBUTS 100.

The role of offer providers 150 is to have an offer of goods/services, to give an access to those goods/services to the universal agent 134 and to handle transactions incoming from the universal agent 134 or (optionally) fully delegate transactions to the universal agent 134. Although two offer providers 150 are depicted in FIG. 1, there are no limits on the number of offer providers 150 using CNBUTS 100.

### CNBUTS 100 Interactions

The CNBUTS 100 undertakes a number of actions/processes including, for example, offer construction, marketplace construction, and transaction processing.

Offer Construction

The offering developer 140 develops an offering system 144 and, by using the offering interface broker 136, integrates this offering system 144 with the universal agent 134. The offer provider 150 uses the offering system 144 to define goods/services, which will be available for transactions and describes those goods/services in the offering system 144 by defining their features such as, for example: price, needed resources, place, availability, etc. The offer provider 150 may also include information indicating whether the universal agent 134 is delegated authority to complete transactions relating to an offer of the goods/services. Using available features in the offering system 144, the offer provider 150 creates delegations by deciding which goods/service transactions will be handled by the offer provider 150 and which will be handled by the universal agent 134. When the offer provider 150 decides that the offer is ready, the offer provider 150 commands the offering system 144 to place the offer with the universal agent 134. The offering system 144 does not have to be connected permanently to the universal agent 134, but when not connected the goods/services without delegations will not be available to the buyers/clients 110. Goods/Services without delegations are available only when the offering system 144 is connected to the universal agent 134.

Marketplace Construction

The marketplace supplier 120, using the marketplace interface broker 132 integrates a given marketplace 124 with the universal agent 134. The marketplace supplier 120 chooses at least one business domain from the domains available in the universal agent 134 and develops at least one media interface 122 through which buyers/clients 110 will have an access to the goods/services from this domain. The marketplace 124 stays permanently connected through a computer network (not shown in FIG. 1) with the universal agent 134 and presents to the buyers/clients 110 up to date offers with available goods/services only.

Transaction Processing

The buyer/client 110 gets the information about the offer and its availability on a marketplace 124 through a chosen media interface 122, which enables marketplace to buyer/client-directed communication. If this media interface 122 also supports a return communication channel (e.g., it is two-way), the buyer/client 110 uses it for completing the transaction for a chosen good/service. When the chosen media interface 122 does not have a return channel, the buyer/client 110 uses another available media interface 122 with return communication capabilities to complete this transaction. As the marketplace 124 stays connected to the universal agent 134, the transaction request is transmitted, over a computer network (not shown in FIG. 1), immediately from the marketplace 124 to the universal agent 134. If the universal agent 134 was given delegation for the chosen goods/services, it accepts or refuses the transaction. If not, the universal agent 134 (over a computer network) informs the offering system 144 and the offer provider 150 about the transaction request. The offer provider 150 decides whether to accept it or refuse it. When the transaction status is set, the universal agent 134 (over a computer network) informs the marketplace 124 about this status and the marketplace 124 makes this information available to the buyer/client 110 through a given media interface 122.

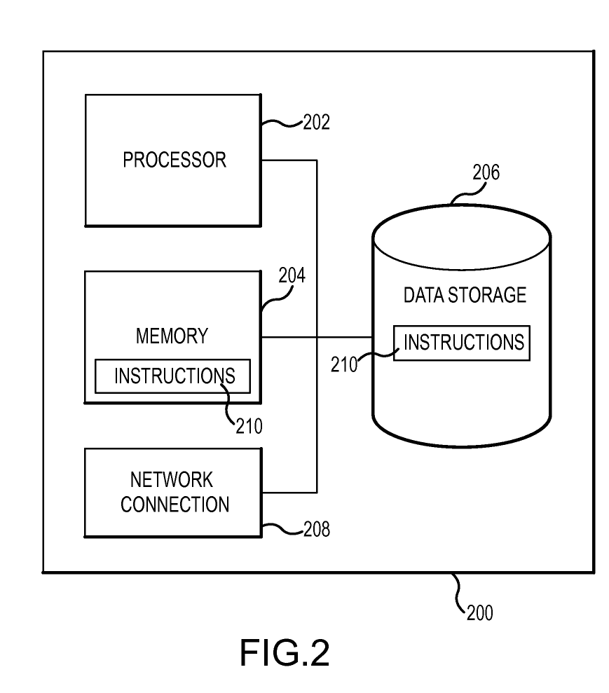

Referring now to FIG. 2, one embodiment of an exemplary computing system 200 that may be utilized to implement one or more of the various components of the CNBUTS 100 is shown. For example, the universal agent 134, the offering systems 144, and the marketplaces 124 may be implemented using separate computing systems 200 such as depicted in FIG. 2. Computing system 200 depicted in FIG. 2 is not the only computing system architecture that be utilized to implement various components of CNBUTS 100 and differently configured computing systems or the like may be utilized. Further, multiple computing systems 200 such as depicted in FIG. 2 may be utilized to implement a single component within the CNBUTS 100.

Computing system 200 includes, among other components, a processor 202, memory 204, a data storage device 206 (e.g., a hard drive), and a network connection device 208 (e.g., an Ethernet card, a WiFi network card, a modem or the like). Computing system 200 may include additional components that are not illustrated in FIG. 2 including, for example, a power supply, an input device (e.g., a keyboard, a pointing device), and an output device (e.g., a display). The processor 202 executes computer program instructions 210 stored in memory 204 and/or on the data storage device 206 that enable the computing system 200 to provide the desired functionality of the component within the CNBUTS 100 that computing system 200 is being used to implement.

The computer program instructions 210 may, for example in the case of computing system 200 being used to implement a marketplace 124, include instructions to provide the various functionalities of the marketplace 124 including offering goods/services available at the universal agent 134 to the buyers/clients 110 via the media interfaces 122 and mediating in the transaction process of such goods/services between the universal agent 134 and the buyers/clients 110. In this regard, the computer program instructions 210 executable by the processor 202 of the computing system 200 may also implement some portion or the entirety of the marketplace interface broker 132 corresponding with the marketplace 124.

The computer program instructions 210 may, for example in the case of computing system 200 being used to implement the universal agent 134, include instructions enabling the computing system 200 to provide the various functionalities of the universal agent 134 including passing goods/services offers from the offering systems 144 to the marketplaces 124, informing offer providers 150 through the offering systems 144 about transaction requests from the marketplaces 124, and processing (when delegated authority) on behalf of the offer providers 150 all kinds of transactions by buyers/clients 110 of all kinds of goods/services. In this regard, the computer program instructions 210 executable by the processor 202 of the computing system 200 may also implement some portion or the entirety of the marketplace interface brokers 132 and the offering interface brokers 136.

The computer program instructions 210 may, for example in the case of computing system 200 being used to implement an offering system 144, include instructions to provide the various functionalities of the offering system 144 including enabling offer providers 150 to define and manage goods/services through media interfaces 142, making the goods/services offered by service providers 150 available to the universal agent 134, and mediating in the transaction process between the universal agent 134 and the offer providers 150. In this regard, the computer program instructions 210 executable by the processor 202 of the computing system 200 may also implement some portion or the entirety of the offering interface broker 136 corresponding with the offering system 144.

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. An architecture of a computer network based universal transaction system enabling transactions between one or more offer providers and one or more customers, wherein the transactions relate to offers of wares by the offer providers, said system comprising:
a universal agent system, said universal agent system being enabled to receive one or more offers of wares available for transaction, wherein the offers of wares are defined by the offer providers;
one or more offering systems, each said offering system enabling offer providers to define one or more offers of wares available for transaction with customers, wherein an offer of wares includes information indicating whether said universal agent system is delegated authority to complete transactions with customers relating to the offer of wares; and
one or more marketplace systems, each said marketplace system being enabled to receive the one or more offers of wares from said universal agent system, present the customers the one or more offers of wares, receive transaction requests from the customers relating to the one or more offers of wares, and communicate received transaction requests to said universal agent system;
wherein said universal agent system communicates the one or more offers of wares from said one or more offering systems to said one or more marketplace systems; and
wherein said universal agent system processes transaction requests received from said one or more marketplace systems.

2. The system of claim 1 further comprising:
one or more offering interface brokers, each said offering interface broker corresponding with one of said offering systems and being enabled to connect said corresponding offering system with said universal agent system for communication there between via a computer network.

3. The system of claim 1 further comprising:
one or more marketplace interface brokers, each said marketplace interface broker corresponding with one of said one or more marketplace systems and being enabled to connect said corresponding marketplace system with said universal agent system for communication there between via a computer network.

4. The system of claim 1 further comprising:
at least one media interface providing at least one-way communication from said one or more marketplace systems to the customers, wherein the offers of wares available for transaction are communicated from said one or more marketplace systems to the customers via said at least one media interface.

5. The system of claim 4 wherein said at least one media interface provides two-way communication between said one or more marketplace systems and the customers, wherein the transaction requests are communicated from the customers to said one or more marketplace systems via the same said at least one media interface.

6. The system of claim 4 further comprising:
at least one additional media interface providing at least return channel communication from the customers to said one or more marketplace systems, wherein the transaction requests are communicated from the customers to said one or more marketplace systems via said at least one additional media interface.

7. The system of claim 1 further comprising:
at least one media interface enabling two-way communication between said one or more offering systems and the offer providers, wherein the at least one media interface enables operation of said one or more offering systems by the offer providers to define offers of wares available for transaction.

8. The system of claim 1 wherein the offer providers directly control operation of said one or more offering systems to define offers of wares available for transaction.

9. The system of claim 1 wherein said universal agent system completes transaction requests received from said one or more marketplace systems for offers of wares including information indicating that said universal agent system is delegated authority to complete transactions.

10. The system of claim 1 wherein at least one offer of wares includes information indicating that said universal agent system is not delegated authority to complete transactions relating thereto, and wherein said universal agent system informs the offer providers about the transaction requests for which said universal agent system is not delegated authority to complete through said one or more offering systems.

11. The system of claim 1 wherein said universal agent system, said one or more offering systems, and said one or more marketplace systems each comprise a separate computer processor and software code separately executable by said separate computer processors.

12. The system of claim 11 wherein said separate computer processors comprising said universal agent system and said one or more offering systems are connectable via a computer network, and wherein said separate computer processors comprising said universal agent system and said one or more marketplace systems are connectable via a computer network.

13. The system of claim 1 wherein said system includes only a single universal agent system communicating offers of wares from a plurality of offering systems to a plurality of marketplace systems and processing transaction requests received from said plurality of marketplace systems.

14. The system of claim 1 wherein a ware offered by the one or more offer providers comprises a service.

15. The system of claim 1 wherein a ware offered by the one or more offer providers comprises a good.

16. The system of claim 1 wherein a ware offered by the one or more offer providers comprises a combination of a good and a service.

17. An architecture of a computer network based universal transaction system enabling transactions between one or more offer providers and one or more customers, wherein the transactions relate to offers of wares by the offer providers, said system comprising:
a universal agent system implemented in the form of computer readable program code executable by a computer processor, said universal agent system being enabled to receive one or more offers of wares available for transaction, wherein the offers of wares are defined by the offer providers;
a plurality of offering systems implemented in the form of computer readable program code executable by separate computer processors, each said offering system enabling offer providers to define one or more offers of wares available for transaction with customers, wherein an offer of wares includes information indicating whether said universal agent system is delegated authority to complete transactions with customers relating to the offer of wares;
a plurality of offering interface brokers, each said offering interface broker corresponding with one of said offering systems and providing an interface between said corresponding offering system and said universal agent system for communication via a computer network between the computer processor executing universal agent system program code and the computer processor executing offering system program code;
a plurality of marketplace systems implemented in the form of computer readable program code executable by separate computer processors, each said marketplace system being enabled to receive the one or more offers of wares from said universal agent system, present the customers the one or more offers of wares, receive transaction requests from the customers relating to the one or more offers of wares, and communicate received transaction requests to said universal agent system;
a plurality of marketplace interface brokers, each said marketplace interface broker corresponding with one of said one or more marketplace systems and providing an interface between said corresponding marketplace system and said universal agent system for communication via a computer network between the computer processor executing universal agent system program code and the computer processor executing marketplace system program code;
wherein said universal agent system communicates the one or more offers of wares from said plurality of offering systems to said plurality of marketplace systems using the offering and marketplace interface brokers; and
wherein said universal agent system processes transaction requests received from said plurality of marketplace systems.

18. The system of claim 17 wherein a ware offered by the one or more offer providers comprises a service.

19. The system of claim 17 wherein a ware offered by the one or more offer providers comprises a good.

20. The system of claim 17 wherein a ware offered by the one or more offer providers comprises a combination of a good and a service.

21. The system of claim 17 wherein the offer providers directly control operation of said plurality of offering systems to define offers of wares available for transaction.

22. The system of claim 17 wherein said universal agent system completes transaction requests received from said plurality of marketplace systems for offers of wares including information indicating that said universal agent system is delegated authority to complete transactions.

23. The system of claim 17 wherein at least one offer of wares includes information indicating that said universal agent system is not delegated authority to complete transactions relating thereto, and wherein said universal agent system informs the offer providers about the transaction requests for which said universal agent system is not delegated authority to complete through said plurality of offering systems.
